(19) United States
(12) Patent Application Publication
(10) Pub. No.: US 2026/0044059 A1
(43) Pub. Date: Feb. 12, 2026

(54) PROJECTION APPARATUS WITH HIGH RESOLUTION

(71) Applicant: QISDA CORPORATION, Taoyuan City (TW)

(72) Inventors: Jia-Ming Zhang, Taichung City (TW); Ching-Tze Huang, Taoyuan City (TW)

(73) Assignee: QISDA CORPORATION, Taoyuan City (TW)

(21) Appl. No.: 19/014,246

(22) Filed: Jan. 9, 2025

(30) Foreign Application Priority Data
Aug. 8, 2024 (TW) 113129786

(51) Int. Cl. G03B 21/14; G02B 26/00; G02B 26/08; G02B 26/10; G03B 21/00

(52) U.S. Cl. CPC G03B 21/142; G02B 26/008; G02B 26/0833; G02B 26/105; G03B 21/008

(57) ABSTRACT

A projection apparatus with high resolution includes a digital micromirror device and a galvanometer mirror. The digital micromirror device includes a plurality of digital micromirrors set in orthogonal arrangement. The galvanometer mirror includes a drive circuit board and a translucent lens. The translucent lens aligns with the digital micromirror device with a diagonal direction of the translucent lens perpendicular or parallel to an arrangement direction of the plurality of digital micromirrors. The drive circuit board can vibrate the translucent lens so that a light beam projected by the projection apparatus is moved in the diagonal direction.

### BACKGROUND OF THE INVENTION

### 1. Field of the Invention The present invention relates to a projection apparatus, and more particularly, to a projection apparatus with high resolution.

### 2. Description of the Prior Art

Please refer to FIG. 1 and FIG. 2. FIG. 1 and FIG. 2 are diagrams of a digital micromirror device and a galvanometer mirror in prior art. The digital micromirror device 10 in FIG. 1 has a plurality of digital micromirrors set in orthogonal arrangement, and is paired with the galvanometer mirror 12 that conforms to a motion mode of arrow assembly A1. The digital micromirror device 14 in FIG. 2 has a plurality of digital micromirrors set in diagonal arrangement, and is paired with the galvanometer mirror 16 that conforms to a motion mode of arrow assembly A2. The digital micromirror device set in the specific arrangement mode is only applied for the galvanometer mirror with the corresponding motion mode; for example, the galvanometer mirror 12 in only used for the digital micromirror device 10, instead of the digital micromirror device 14. Since development cost of pixel conversion technology (or a pixel shift resolution system) is expensive, design of a projection apparatus capable of applying the galvanometer mirror with the specific motion mode for the digital micromirror device with multiple arrangement modes is an important issue in the related projector industry.

### SUMMARY OF THE INVENTION

The present invention provides a projection apparatus with high resolution for solving above drawbacks.

According to the claimed invention, a projection apparatus with high resolution includes a digital micromirror device and a galvanometer mirror. The digital micromirror device includes a plurality of digital micromirrors set in orthogonal arrangement. The galvanometer mirror includes a drive circuit board and a translucent lens. The translucent lens aligns with the digital micromirror device in a manner of a diagonal direction of the translucent lens perpendicular or parallel to an arrangement direction of the plurality of digital micromirrors, and the translucent lens is vibrated by the drive circuit board so that a light beam projected by the projection apparatus is moved in the diagonal direction.

According to the claimed invention, a projection apparatus with high resolution includes a digital micromirror device and a galvanometer mirror. The digital micromirror device includes a plurality of digital micromirrors set in diagonal arrangement. The galvanometer mirror includes a drive circuit board and a translucent lens. The translucent lens aligns with the digital micromirror device in a manner of a side direction of the translucent lens being perpendicular or parallel to an arrangement direction of the plurality of digital micromirrors, and the translucent lens is vibrated by the drive circuit board so that a light beam projected by the projection apparatus is moved in the side direction.

According to the claimed invention, a projection apparatus with high resolution includes a lens, a color wheel, a light source device, a digital micromirror device and a galvanometer mirror. The light source device is adapted to emit an illumination beam towards the color wheel. The digital micromirror device is adapted to reflect the illumination beam through the color wheel towards the lens. The digital micromirror device includes a plurality of digital micromirrors set in a specific arrangement direction. The galvanometer mirror is disposed between the digital micromirror device and the lens, and includes a drive circuit board and a translucent lens. The translucent lens is vibrated by the drive circuit board, so that a light beam projected by the projection apparatus is moved at high frequency in a specific moving direction, so as to increase an image resolution of the projection apparatus. A relative placement angle between the galvanometer mirror and the digital micromirror device is adjusted by the projection apparatus based on an angle difference between the specific arrangement direction and the specific moving direction, and the specific moving direction is parallel to the specific arrangement direction.

The projection apparatus of the present invention can include the digital micromirror device having the plurality of digital micromirrors set in a specific arrangement direction, and the galvanometer mirror including the drive circuit board and the translucent lens. The drive circuit board of the galvanometer mirror can vibrate the translucent lens so that the light beam projected through the translucent lens can move at high frequency along a specific moving direction, for increasing image resolution of the projection apparatus. For applying the galvanometer mirror with the specific motion mode (which means the light beam projected through the vibrated translucent lens can be moved at the high frequency along the specific moving direction) to the digital micromirror device with the multiple arrangement modes (such as the digital micromirrors optionally set in one of the specific arrangement directions), the projection apparatus of the present invention can adjust the relative placement angle between the galvanometer mirror and the digital micromirror device in accordance with an angle difference between the specific arrangement direction and the specific moving direction, and the specific moving direction can be substantially parallel to the specific arrangement direction. The projection apparatus of the present invention can change the relative placement angle between the galvanometer mirror and the digital micromirror device, and therefore the galvanometer mirror with the specific placement mode can be used in the digital micromirror device with the multiple arrangement modes to reduce development costs and time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are diagrams of a digital micromirror device and a galvanometer mirror in prior art.

FIG. 3 is a diagram of a projection apparatus according to an embodiment of the present invention.

FIG. 4 is a diagram of a digital micromirror device and a galvanometer mirror according to a first embodiment of the present invention.

FIG. 5 is a diagram of a diagram of the digital micromirror device and the galvanometer mirror according to a second embodiment of the present invention.

FIG. 6 is a diagram of some part of the projection apparatus made in one state according to the embodiment of the present invention.

FIG. 7 is a diagram of some part of the projection apparatus 20 made in another state according to the embodiment of the present invention.

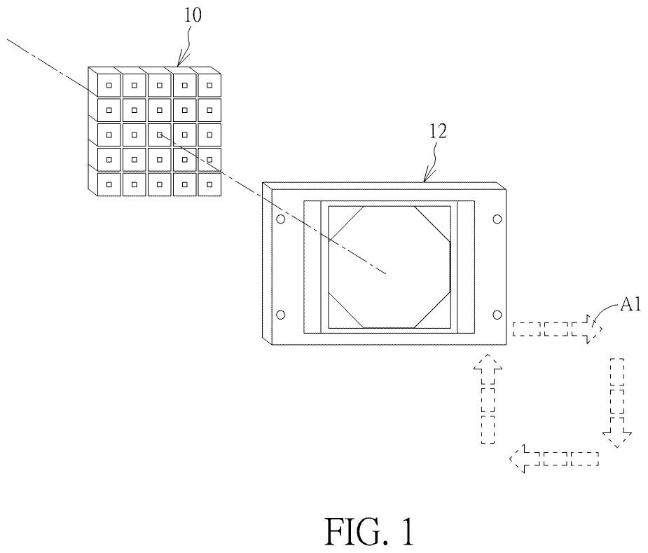

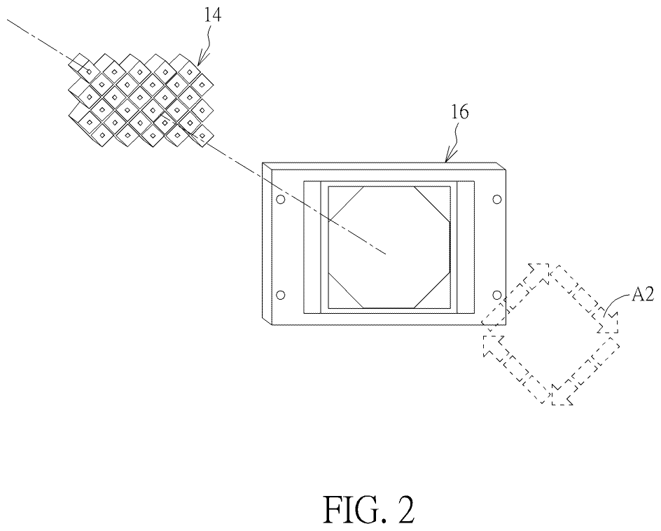

### DETAILED DESCRIPTION

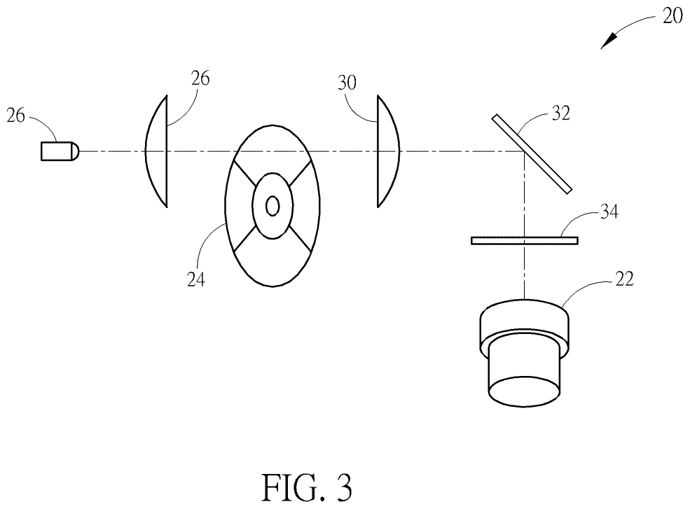

Please refer to FIG. 3. FIG. 3 is a diagram of a projection apparatus 20 according to an embodiment of the present invention. The projection apparatus 20 can include a lens 22, a color wheel 24, a light source device 26, a condenser 28, a relay mirror 30, a digital micromirror device 32 and a galvanometer mirror 34. An illumination beam emitted by the light source device 26 can pass through the condenser 28 towards the color wheel 24; a wavelength range of the illumination beam can depend on a design demand of the projection apparatus 20, and a detailed description is omitted herein for simplicity. The illumination beam passing through the color wheel 24 and the relay mirror 30 can be reflected by the digital micromirror device 32 towards the lens 22. The galvanometer mirror 34 can be disposed between the digital micromirror device 32 and the lens 22, and can be used to move projection pixels a specific distance through micro-movement, so as to superimpose pixel density via persistence of vision for increasing resolution of the projection apparatus 20.

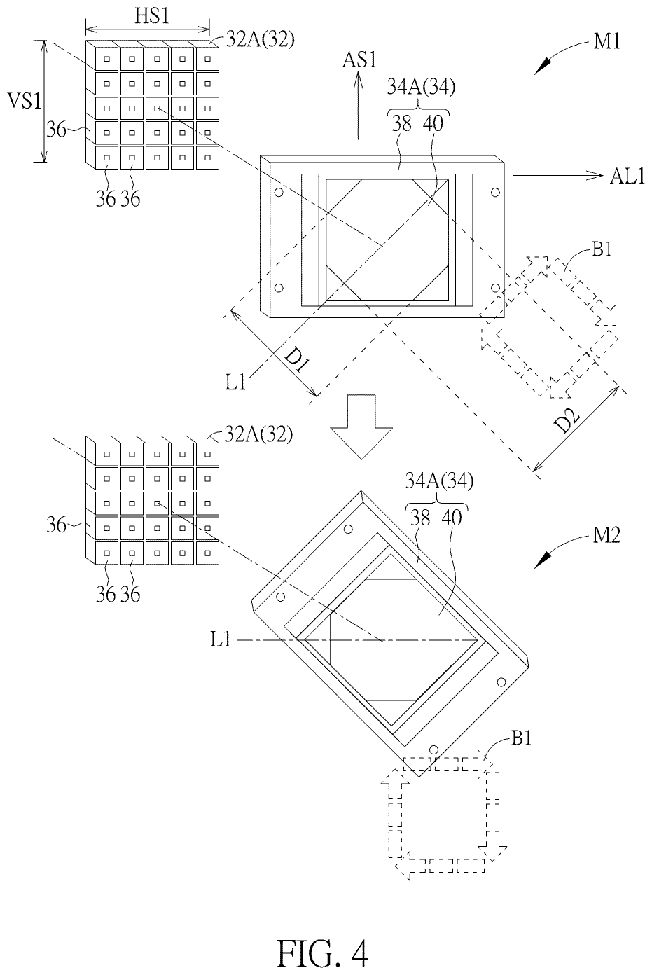

Please refer to FIG. 4. FIG. 4 is a diagram of the digital micromirror device 32A and the galvanometer mirror 34A according to a first embodiment of the present invention. The digital micromirror device 32A in the first embodiment can include a plurality of digital micromirrors 36 set in orthogonal arrangement. The galvanometer mirror 34A can include a drive circuit board 38 and a translucent lens 40. A motion mode of a light beam projected through the galvanometer mirror 34A can correspond to arrow assembly B1 (such as in a rhombus-shaped moving direction), and the motion mode of the light beam provided by the galvanometer mirror 34A vibrated in a state M1 cannot be applied for the digital micromirror device 32A; therefore, the projection apparatus 10 of the present invention can utilize a drive mechanism (which is not marked in the figures) attached to the galvanometer mirror 34A, or the translucent lens 40 adjusted by the drive circuit board 38, or any possible means to align the translucent lens 40 with the digital micromirror device 32A in a manner of a diagonal L1 of the translucent lens 40 being perpendicular or parallel to an arrangement direction of the plurality of digital micromirrors 36, such as being switched from the state M1 to a state M2; it should mentioned that the present invention can set the galvanometer mirror 34A in the state M1 or the state M2 according to an arrangement mode of the digital micromirror device 32A when the projection apparatus 20 is manufactured.

When the translucent lens 40 of the galvanometer mirror 34A is adjusted and constrained at a preset angle due to the motion mode and arrangement of the digital micromirror 36, the drive circuit board 38 of the galvanometer mirror 34A can vibrate the translucent lens 40 in a uniaxial manner or in a biaxial manner, and the light beam projected through the digital micromirror device 32A and the galvanometer mirror 34A can be moved along the motion mode of the arrow assembly B1, which means the light beam projected by the projection apparatus 20 can be moved along the diagonal L1 or a direction of the arrow assembly B1 in the state M2, so as to achieve a design purpose of pixel conversion technology (or a pixel shift resolution system).

In addition, the drive circuit board 38 can have a major axis AL1 and a minor axis AS1. The drive circuit board 38 can vibrate the translucent lens 40 so that the light beam projected through the translucent lens 40 can be moved relative to the major axis AL1 and/or the minor axis AS1 in rhombus-shaped movement; conventional usage only applies the drive circuit board 38 to the digital micromirrors set in diagonal arrangement, instead of the digital micromirror device 32A having the plurality of digital micromirrors 36 set in the orthogonal arrangement. To overcome the defect, the projection apparatus 10 of the present invention can vibrate the translucent lens 40 by the drive circuit board 38 to execute the pixel conversion technology, and further can pre-change a placement angle of the galvanometer mirror 34A relative to the digital micromirror device 32A, which means the projection apparatus 20 can be constrained at the state M2 in manufacturing process, so that the galvanometer mirror 34A which has the motion mode of the light beam corresponding to the arrow assembly B1 can be applied for the digital micromirror device 32A having the plurality of digital micromirrors 36 set in the orthogonal arrangement, and an additional galvanometer mirror is no need to configure for the digital micromirror device 32A.

It should be mentioned that lengths D1 and D2 of two diagonals of the translucent lens 40 of the galvanometer mirror 34A in the first embodiment can be greater than a maximal vertical dimension VS1 and a maximal horizontal dimension HS1 of the plurality of digital micromirrors 36 set in the orthogonal arrangement of the digital micromirror device 32A, and the translucent lens 40 of the adjusted galvanometer mirror 34A (such as being switched from the state M1 to the state M2) can cover all the digital micromirrors 36. In the first embodiment, the switching between the state M1 and the state M2 can be preset at forty-five degrees (such as the foresaid preset angle); an actual value of the preset angle is not limited to the foresaid embodiment, and can depend on arrangement of the digital micromirror 36 and the motion mode of the light beam projected through the galvanometer mirror 34A.

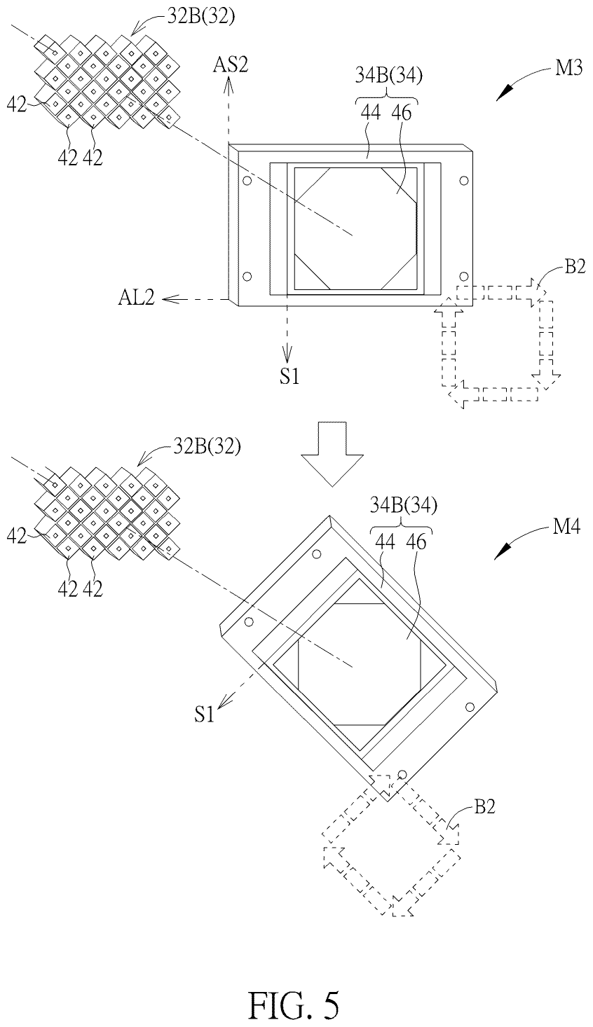

Please refer to FIG. 5. FIG. 5 is a diagram of a diagram of the digital micromirror device 32B and the galvanometer mirror 34B according to a second embodiment of the present invention. The digital micromirror device 32B in the second embodiment can include the plurality of digital micromirrors 42 set in the diagonal arrangement. The galvanometer mirror 34B can include a drive circuit board 44 and a translucent lens 46. The motion mode of a light beam projected through the galvanometer mirror 34B can correspond to arrow assembly B2 (such as in an orthogonal moving direction), and the motion mode of the light beam provided by the galvanometer mirror 34B vibrated in a state M3 cannot be applied for the digital micromirror device 32B; therefore, the projection apparatus 10 of the present invention can utilize a drive mechanism (which is not marked in the figures) attached to the galvanometer mirror 34B, or the translucent lens 46 adjusted by the drive circuit board 44, or any possible means to align the translucent lens 46 with the digital micromirror device 32B in a manner of a side S1 of the translucent lens 46 being perpendicular or parallel to an arrangement direction of the plurality of digital micromirrors 42, such as being switched from the state M3 to a state M4; as mentioned above, the state switching operation can be completed when the projection apparatus 20 is manufactured.

When the translucent lens 46 of the galvanometer mirror 34B is adjusted and constrained at the preset angle (for example, the switching between the state M3 and the state M4 can be preset at forty-five degrees) due to the motion mode and arrangement of the digital micromirror 42, the drive circuit board 44 of the galvanometer mirror 34B can vibrate the translucent lens 46 in the uniaxial manner or in the biaxial manner, and the light beam projected through the digital micromirror device 32B and the galvanometer mirror 34B can be moved along the motion mode of the arrow assembly B2, which means the light beam projected by the projection apparatus 20 can be moved along the side S1 or a direction of the arrow assembly B2 in the state M4, so as to achieve the design purpose of the pixel conversion technology (or the pixel shift resolution system).

Accordingly, the drive circuit board 44 can have a major axis AL2 and a minor axis AS2. The drive circuit board 44 can vibrate the translucent lens 46 so that the light beam projected through the translucent lens 46 can be moved relative to the major axis AL1 and/or the minor axis AS1 in the orthogonal movement; conventional usage only applies the drive circuit board 44 to the digital micromirrors set in orthogonal arrangement, instead of the digital micromirror device 32B having the plurality of digital micromirrors 42 set in the diagonal arrangement. To overcome the defect, the projection apparatus 10 of the present invention can vibrate the translucent lens 46 by the drive circuit board 44 to execute the pixel conversion technology, and further can pre-change the placement angle of the galvanometer mirror 34B relative to the digital micromirror device 32B, which means the projection apparatus 20 can be constrained at the state M4 in the manufacturing process, so that the galvanometer mirror 34B which has the motion mode of the light beam corresponding to the arrow assembly B2, can be applied for the digital micromirror device 32B having the plurality of digital micromirrors 42 set in the diagonal arrangement, and an additional galvanometer mirror is no need to configure for the digital micromirror device 32B.

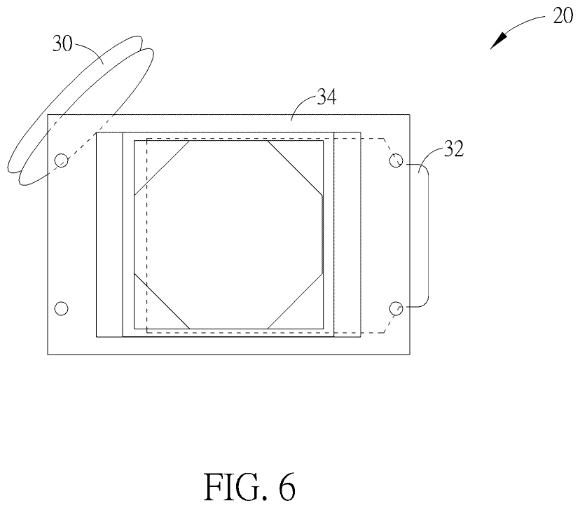

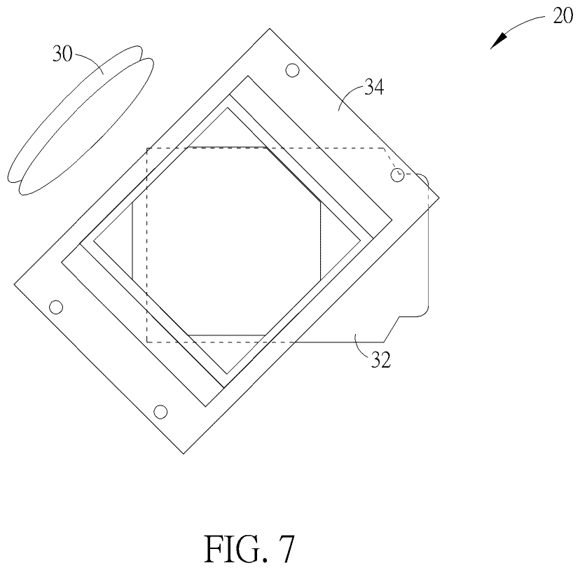

Please refer to FIG. 6 and FIG. 7. FIG. 6 is a diagram of some part of the projection apparatus 20 made in the state M1 according to the embodiment of the present invention. FIG. 7 is a diagram of some part of the projection apparatus 20 made in the state M2 according to the embodiment of the present invention. As shown in FIG. 6, if the digital micromirror device 32 is paired with the galvanometer mirror 34 with the wrong state (such as the state M1), corners of the galvanometer mirror 34 may have structural interference with the prism (such as the relay mirror 30 or other optical elements) of the projection apparatus 20. Therefore, as shown in FIG. 7, the present invention can change the placement angle of the galvanometer mirror 34 relative to the digital micromirror device 32 (such as being switched from the state M1 to the state M2) for manufacturing the projection apparatus 20, and the galvanometer mirror 34 can be constrained in the state M2; the corners of the galvanometer mirror 34 does not have the structural interference with the prism (such as the relay mirror 30 or other optical elements) of the projection apparatus 20; thus, a distance between the galvanometer mirror 34 and the prism can be shortened to achieve advantages of reducing an overall size of the projection apparatus 20 and increasing illumination efficiency of the projection apparatus 20.

In conclusion, the projection apparatus of the present invention can include the digital micromirror device having the plurality of digital micromirrors set in a specific arrangement direction, and the galvanometer mirror including the drive circuit board and the translucent lens. The drive circuit board of the galvanometer mirror can vibrate the translucent lens so that the light beam projected through the translucent lens can move at high frequency along a specific moving direction, for increasing image resolution of the projection apparatus. For applying the galvanometer mirror with the specific motion mode (which means the light beam projected through the vibrated translucent lens can be moved at the high frequency along the specific moving direction) to the digital micromirror device with the multiple arrangement modes (such as the digital micromirrors optionally set in one of the specific arrangement directions), the projection apparatus of the present invention can adjust the relative placement angle between the galvanometer mirror and the digital micromirror device in accordance with an angle difference between the specific arrangement direction and the specific moving direction, and the specific moving direction can be substantially parallel to the specific arrangement direction.

For example, when the specific arrangement direction of the plurality of digital micromirrors is an orthogonal arrangement direction, and the specific moving direction of the light beam projected through the vibrated galvanometer mirror is a rhombus-shaped moving direction, as the embodiment shown in FIG. 4, the placement angle of the galvanometer mirror relative to the digital micromirror device can be adjusted to switch from the state M1 to the state M2 when the projection apparatus 20 is in the manufacturing process. When the specific arrangement direction of the plurality of digital micromirrors is the rhombus-shaped moving direction, and the specific moving direction of the light beam projected through the vibrated galvanometer mirror is the orthogonal moving direction, as the embodiment shown in FIG. 5, the placement angle of the galvanometer mirror relative to the digital micromirror device can be adjusted to switch from the state M3 to the state M4 when the projection apparatus 20 is in the manufacturing process. Comparing to the prior art, the projection apparatus of the present invention can change the relative placement angle between the galvanometer mirror and the digital micromirror device, and therefore the galvanometer mirror with the specific placement mode can be used in the digital micromirror device with the multiple arrangement modes to reduce development costs and time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projection apparatus with high resolution comprising:
a digital micromirror device comprising a plurality of digital micromirrors set in orthogonal arrangement; and
a galvanometer mirror comprising a drive circuit board and a translucent lens, the translucent lens aligning with the digital micromirror device in a manner of a diagonal direction of the translucent lens being perpendicular or parallel to an arrangement direction of the plurality of digital micromirrors, the translucent lens being vibrated by the drive circuit board so that a light beam projected by the projection apparatus is moved in the diagonal direction.

2. The projection apparatus of claim 1, further comprising:
a lens;
a color wheel; and
a light source device adapted to emit an illumination beam, the illumination beam passing through the color wheel and being reflected by the digital micromirror device to project onto the lens through the galvanometer mirror, so as to increase an image resolution of the projection apparatus.

3. The projection apparatus of claim 1, wherein the drive circuit board has a major axis and a minor axis, the translucent lens is vibrated by the drive circuit board so that the light beam makes a rhombus-shaped movement relative to the major axis and/or the minor axis.

4. The projection apparatus of claim 1, wherein a length of each of diagonals of the translucent lens is greater than a maximal vertical dimension and a maximal horizontal dimension of the plurality of digital micromirrors.

5. A projection apparatus with high resolution comprising:
a digital micromirror device comprising a plurality of digital micromirrors set in diagonal arrangement; and
a galvanometer mirror comprising a drive circuit board and a translucent lens, the translucent lens aligning with the digital micromirror device in a manner of a side direction of the translucent lens being perpendicular or parallel to an arrangement direction of the plurality of digital micromirrors, the translucent lens being vibrated by the drive circuit board so that a light beam projected by the projection apparatus is moved in the side direction.

6. The projection apparatus of claim 5, further comprising:
a lens;
a color wheel; and
a light source device adapted to emit an illumination beam, the illumination beam passing through the color wheel and being reflected by the digital micromirror device to project onto the lens through the galvanometer mirror, so as to increase an image resolution of the projection apparatus.

7. The projection apparatus of claim 5, wherein the drive circuit board has a major axis and a minor axis, the translucent lens is vibrated by the drive circuit board so that the light beam makes an orthogonal movement relative to the major axis and/or the minor axis.

8. The projection apparatus of claim 5, wherein a length of each of diagonals of the translucent lens is greater than a maximal vertical dimension and a maximal horizontal dimension of the plurality of digital micromirrors.

9. A projection apparatus with high resolution comprising:
a lens;
a color wheel;
a light source device adapted to emit an illumination beam towards the color wheel;
a digital micromirror device adapted to reflect the illumination beam through the color wheel towards the lens, the digital micromirror device comprising a plurality of digital micromirrors set in a specific arrangement direction; and
a galvanometer mirror disposed between the digital micromirror device and the lens, and comprising a drive circuit board and a translucent lens, the translucent lens being vibrated by the drive circuit board so that a light beam projected by the projection apparatus is moved at high frequency in a specific moving direction, so as to increase an image resolution of the projection apparatus;
wherein a relative placement angle between the galvanometer mirror and the digital micromirror device is adjusted by the projection apparatus based on an angle difference between the specific arrangement direction and the specific moving direction, and the specific moving direction is parallel to the specific arrangement direction.

10. The projection apparatus of claim 9, wherein the specific arrangement direction is an orthogonal arrangement direction, and the specific moving direction is a rhombus-shaped moving direction.

11. The projection apparatus of claim 9, wherein the specific arrangement direction is a diagonal arrangement direction, and the specific moving direction is an orthogonal moving direction.

12. The projection apparatus of claim 9, wherein a length of each of diagonals of the translucent lens is greater than a maximal vertical dimension and a maximal horizontal dimension of the plurality of digital micromirrors.
